(19) United States
(12) Patent Application Publication
(10) Pub. No.: US 2006/0085692 A1
(43) Pub. Date: Apr. 20, 2006

(54) Bus fault detection and isolation

(75) Inventors: Richard Berbaum, Maine, NY (US); Edward R. Bestle, Owego, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corp.

(21) Appl. No.: 11/242,855

(22) Filed: Oct. 5, 2005

Related U.S. Application Data
(60) Provisional application No. 60/615,952, filed on Oct. 6, 2004.
(60) Provisional application No. 60/616,221, filed on Oct. 7, 2004.

(51) Int. Cl. G06F 11/00

(52) U.S. Cl. 714/43

(57) ABSTRACT

A bus fault detection and isolation system and method is disclosed that can operate non-intrusively to detect and isolate faults in a bus, such as a dual redundant MIL STD 1553 bus. The system and method of the present invention can be configured to operate within a bus controller using existing system commands and variables defined for testing. No additional equipment may be needed to utilize the bus fault detection and isolation system and method, so no additional failure points are introduced and the bus is in an unmodified state while fault detection and isolation takes place. Further, the bus fault detection and isolation system and method of the present invention may use accumulator variables to detect an intermittent fault which may then be isolated later even if the fault condition is no longer present on the bus.

This application claims the benefit under 35 U.S.C. § 119(e) to U.S. provisional application Ser. No. 60/615,952, filed on Oct. 6, 2004, entitled “Reasonableness Testing and Bus Diagnostics” and U.S. provisional application Ser. No. 60/616,221, filed on Oct. 7, 2004, entitled “Reasonableness Testing and Bus Diagnostics”, both of which are incorporated herein by reference in their entirety.

The present invention relates generally to a diagnostic tool and more particularly to a system and method for non-intrusive bus fault detection and isolation.

### BRIEF DESCRIPTION OF THE DRAWINGS

FIG. 1 is a block diagram showing a typical dual redundant 1553 bus topology;

FIG. 2 is a flow chart showing an exemplary method of non-intrusive bus fault detection and isolation in accordance with the present invention;

FIG. 3 is a block diagram showing an exemplary 1553 bus with a fault on a main trunk;

FIG. 4 is a block diagram of an exemplary remote terminal with a fault on a connection between the remote terminal and the data bus coupler; and

FIG. 5 is a block diagram of an exemplary 1553 bus showing a coil within the data bus coupler.

### DETAILED DESCRIPTION

The non-intrusive bus fault detection and isolation system and method of the present invention isolates faults to data bus couplers bus terminators and intercoupler wire segments utilizing only system I/O built-in-test (BIT). By assigning unique system I/O fail flags to each bus stub within the bus controller software, the non-intrusive fault detection and isolation system and method of the present invention is able to utilize the bus controller to recognize failed (or powered off) remote terminals (RTs) by assuming that both A and B RT stubs will not be simultaneously faulted. This assumption may be reasonable due to the typical physical separation of individual wire/coupler placement to achieve tolerance to battle damage and to the high reliability individual bus couplers may have.

Generally, the system and method of the present invention utilizes the known topology of the bus segments, the location of the bus controller within the redundant bus, and a minimum set of powered on RTs to localize main bus faults to one bus coupler or intercoupler wire segment. Once the faulted segment of the bus is isolated, a simple re-routing of the main bus around the faulted segment can isolate between the coupler and wire. The isolation may also be performed without rerouting through the use of a multi-meter-checkout.

While the systems and methods of the present invention are described below in reference to a MIL-STD-1553 bus, it should be appreciated that the systems and methods of the present invention may be used with other bus standards, bus protocols, or the like. MIL-STD-1553, published by the U.S. government, describes the “1553” bus and is incorporated herein by reference in its entirety.

Generally, the system and method of the present invention accomplishes fault detection via the BIT capability of the dual redundant bus. In addition to conventional BIT capability, accumulators are added to the operating environment that allow for the detection of intermittent failures. The addition of the accumulators of the operating environment eliminates the need for external sensors or fault filtering functions to be applied to the BIT data to be collected. Fault detection is accomplished via the interface standards (for example 1553 Manchester encoding, or the like) at the bus controller. The present invention goes beyond the basic fault detection capability of the communication error by “breaking” the 1553 bus logically into parts. The fault detection and isolation of the present invention monitors the 1553 backbone or trunk cable and correlates all the subsystems communicating on the bus. Based upon the responses received to the bus monitoring, isolation is determined on the 1553 bus trunk cable down to the data bus coupler. Further, the non-intrusive fault detection and isolation system and method of the present invention allows isolation down to the coil within the data bus coupler. With sufficient responses to bus monitoring, the interface between the data bus coupler and the subsystem may be isolated.

The system and method of the present invention utilizes a server function within the controlling computer and applies I/O status functions to monitor the 1553 bus. By taking the approach of monitoring the device that is connected to the bus via the bus controller of the 1553 bus, the system and method of the present invention is able to control the sequence of communication traffic on the bus and logically break the 1553 bus down to the trunk cable as well as a subsystem to the data bus couplers in order to perform fault isolation.

The non-intrusive fault detection and isolation system of the present invention utilizes a controlling computer to perform 1553 bus testing. This eliminates the need to know the address ID of each subsystem and the need to tap into the bus (which could change test conditions), and utilizes the existing command structure of the 1553 command set. Further, the non-intrusive bus fault detection and isolation system and method of the present invention does not require additional devices to be attached or coupled to the bus. Thus, the possibility of adding ambiguity to the faults is reduced or eliminated. The present invention is performed real time and the BIT data is mapped to identify the subsystem and a particular bus channel utilizing the controlling computer. By adding accumulators to the bus operating system, the fault detection and isolation method of the present invention is able to capture single events and report them real time. Given the ability to identify the difference between a fault and a failure associated with a device on the bus. Further, the capability to map the fault to a trunk cable problem or an interface fault from the data bus coupler to the subsystem is provided.

Generally, the non-intrusive bus fault detection and isolation system of the present invention achieves fault detection/fault isolation through exercising and interpreting BIT results. BIT performs the basic fault detection functions which are then expanded on by the present invention by including the physical configuration mapping of the I/O to perform fault isolation on the bus.

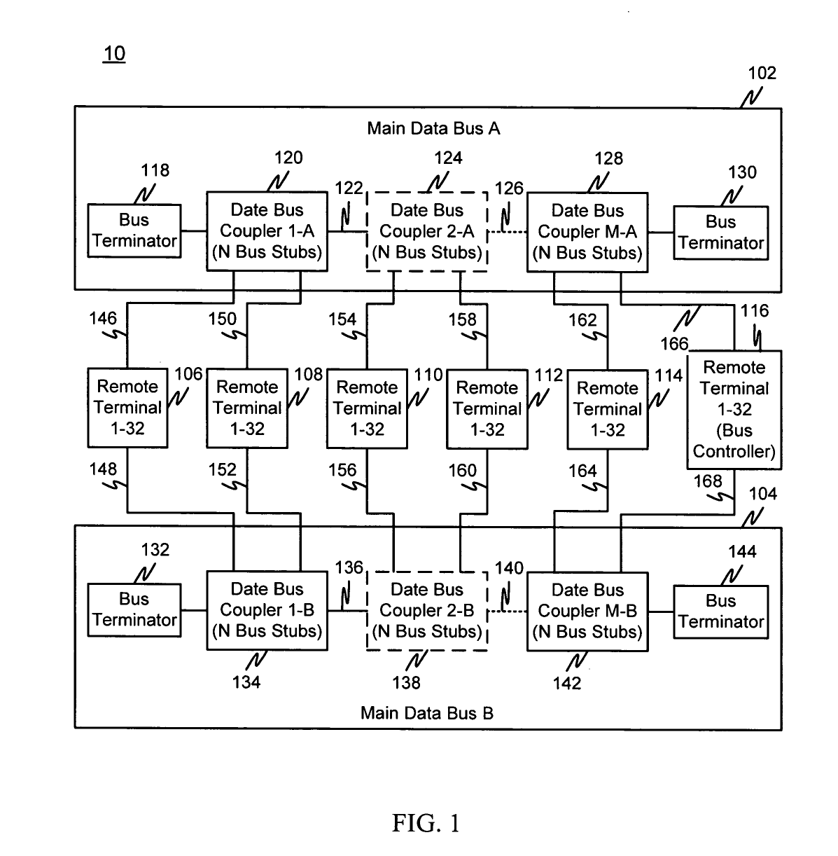

FIG. 1 shows a typical dual redundant bus topology. In particular, a dual redundant bus 10 comprises a Main Data Bus A 102, a Main Data Bus B 104, and groups of remote terminals (106-116). The Main Data Bus A 102 comprises a bus terminator 118, a first data bus coupler 120, a connecting wire 122, a second data bus coupler 124, a connecting wire 126, a third data bus coupler 128, and a bus terminator 130. The Main Data Bus B 104 comprises a bus terminator 132, a first data bus coupler 134, connecting wire 136, a second data bus coupler 138, a connecting wire 140, a third data bus coupler 142, and a bus terminator 144. The remote terminal groups (106-116) may be comprised of a number of remote terminals, for example as shown in the figure that remote terminals comprise 31 remote terminals. A processor within remote terminal 116 functions as the bus controller. Indvidual remote terminals contained within the remote terminal groups (106-116) are connected to Main Data Bus A via connections (146, 150, 154, 158, 162, and 166) and are connected to Main Data Bus B via connections (148, 152, 156, 160, 164, and 168). The remote terminal connections to the main data buses may be comprised of one or more physical lines.

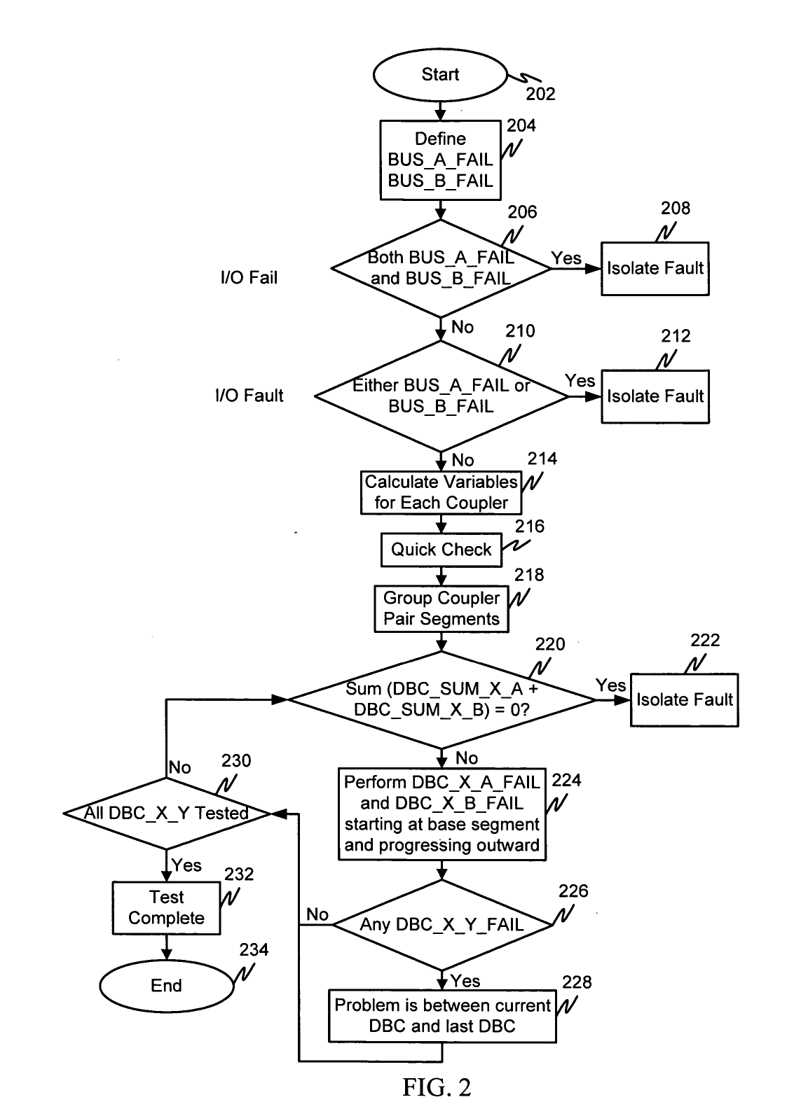

FIG. 2 is a flow chart of an exemplary method for non-intrusive bus fault detection and isolation in accordance with the present invention. In particular, the sequence begins at 202 and continues to step 204. In step 204, the BUS_A_FAIL and BUS_B_FAIL variables are defined. These variables are defined using pass/fail BIT flags for each stub. The sequence continues to step 206.

In step 206, the BUS_A_FAIL and BUS_B_FAIL variables are checked. If both indicate a failed condition (i.e. an I/O Fail has occurred) the control sequence continues to step 208. If both are not failed, the control sequence continues to step 210. In step 208, the fault is isolated. In the instance that both are failed. This failure mode may indicate that either all remote terminals are failed or off, or that there is a catastrophic (multiple main bus faults) failure, or both bus controller stubs have failed, or the bus controller itself has failed. Isolation of this fault requires checking each failure mode.

In step 210, the BUS_A_FAIL and BUS_B_FAIL variables are checked. If either one has failed (i.e. an I/O fault has occurred), the sequence continues to step 212. However, if neither are failed, the sequence continues to step 214. In step 212, the fault is isolated and the failure mode will be associated with the failed bus controller stub or a shorted bus. The isolation of this fault may require a systematic disconnecting of bus wiring radiating out from the coupler containing the bus controller until partial bus operation is regained and identifying the bus portion with the short. If partial bus operation cannot be regained, then the bus controller stub or the base coupler (the one connecting the bus controller) are the prime fault candidates.

In step 214, variables are calculated for each bus coupler. Using the number for the good remote terminals connected to it using the BIT from each associated remote terminal. In other words, the variable is the sum of the good remote terminals connected to a coupler. Once the variables for each of the buses (a and b) have been calculated, the control sequence continues to step 216.

In step 216, a “quick check” is performed to speed the bus testing. If the two couplers at the ends of each bus (A/B) nearest the bus terminator all have at least a DBC_SUM of greater than zero, the bus is a pass for both A and B buses and the check is complete. The control sequence then continues to step 218.

In step 218, the bus couplers are logically grouped in pairs (for example connected remote terminals from A and B buses). These bus couplers (A and B) pairs are defined as segments. The segment containing the bus controller stubs is the base segment. The sequence then continues to step 220.

In step 220, assumptions are validity tested by checking that some remote terminals are on from the current segment toward the ends of the bus. If the sum of (DBC_SUM_X_A+DBC_SUM_X_B) for X being the current remote terminal including all remote terminals toward the end of the bus=zero then the remote terminals toward the end of the bus are failed or powered off. This condition can be diagnosed by checking that all remote terminals are turned on or repaired. The algorithm preconditions have not been met and the test should abort. If the sum of the test variables is zero, the sequence continues to step to 222. If the sum of the variables is not zero, then the sequence continues to step 224. In step 222, the fault is isolated by checking that all remote terminals are turned on or repaired.

In step 224, tests are performed starting at the segment closest to the base segment and progressing outward toward the end of the bus. The DBC_X_A_FAIL and DBC_X_B_FAIL variables are true if one of the following conditions exists:
(DBC_SUM_X_A=0)
AND (DBC_SUM_X_B≠0)
AND (SUM of all DBC_SUM_Y_A, Y from next coupler to end of bus is zero)
AND (SUM of all DBC_SUM_Y_B, Y from next coupler to end of bus is greater than zero)

If a DBC_X-Y_FAIL is found, the problem is between the current DBC and the last DBC, toward the base DBC, that has a non-zero DBC_SUM. Isolating to the interconnecting wire and these DBCs is immediate. Isolation can be improved by insuring all closer DBCs have remote terminals turned on. If the DBC_SUMs are zero for any of these segments, then insure that all of these remote terminals are on and then retest. This method will reduce the single wire segment and two DBCs. If an alternate bus controller is available in the system that is attached to a different DBC then isolation can be further improved by retesting with the alternate BC and correlating the two fault groups and looking for a fault group that is a union of the two tests. If any DBC_X-Y_FAIL variable failures were detected then the sequence proceeds to step 228. If no failures were detected, then the sequence proceeds to step 230.

In step 228 the problem is isolated to a location between the current DBC and the last DBC and the sequence proceeds to step 230.

In step 230, if all DBCs have been tested, then the sequence proceeds to step 232. If all DBCs have not been tested then the sequence continues back to step 224.

In step 232 the test is complete and the control sequence continues to step 234, where the control sequence ends.

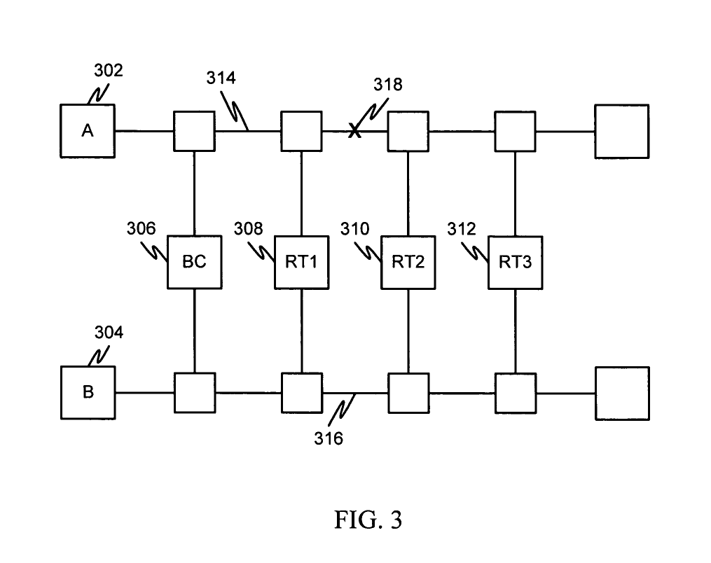

FIG. 3 is a block diagram showing an exemplary 1553 bus with a fault on a main trunk. In particular, the 1553 bus consists of two buses, an A bus 302 and a B bus 304, an A trunk 314 and a B trunk 316, a bus controller 306, a first remote terminal (RT1) 308, a second remote terminal (RT2) 310, and a third remote terminal (RT3) 312. In FIG. 3, there is also shown a fault 318 on the A trunk 314.

In operation, the method of the present invention in an exemplary embodiment as software on the bus controller 306 checks the remote terminals in order of physical proximity. In the diagram the remote terminals are shown in a logical order that corresponds to physical order, however, it should be appreciated that remote terminals may be located along the bus in a physical configuration that differs from their logical address assignment.

Table 1 below represents the results of the remote terminal tests as performed by the fault detection and isolation software of the present invention in the bus controller 306.

TABLE 1

| | A Side | B Side |
|---|---|---|
| RT1 | PASS | PASS |
| RT2 | FAIL | PASS |
| RT3 | FAIL | PASS |

Based on the test result data as shown above in Table 1, the software determines that all three remote terminals are functioning, because the B side tests all passed. The software also determines that there is a fault on the main trunk on the A side because remote terminals 2 and 3 failed on the A side tests. The software can make the determination that it is a main trunk failure because if it were a connection failure between the trunk and either remote terminal 2 or 3, the test results would only show a fail for the remote terminal with the faulty connection.

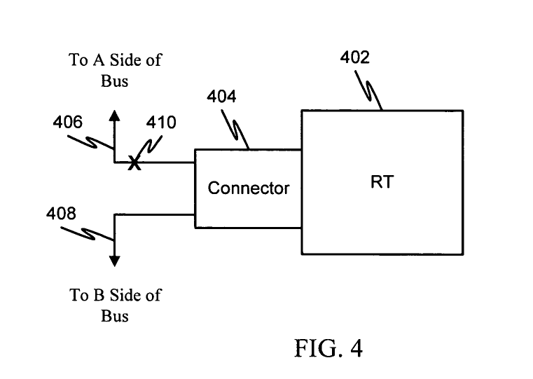

FIG. 4 is a block diagram of an exemplary remote terminal with a fault on a connection between the remote terminal and the data bus coupler. In particular, a remote terminal 402 comprises a connector 404, an A side connection link 406, and a B side connection link. Further, FIG. 4 shows a fault 410 on the A side connection link 406.

The method of the present invention, when applied to the fault condition shown in FIG. 4 can isolate the fault to the A side connection link 406 by determining that the A side and B side trunks were functioning properly. Then, by determining that the remote terminal 402 was communicating on the B side, the connector 404 and the remote terminal 402 could be eliminated from the possible fault list. Thus, the fault could be isolated to the connection link 406 between the connector 404 and a data bus coupler (not shown).

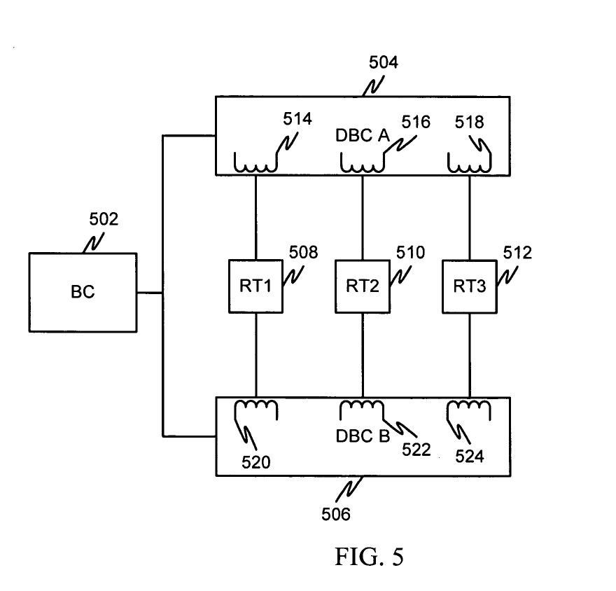

FIG. 5 is a block diagram of a exemplary 1553 bus showing isolation of a fault to a coil within the data bus coupler. In particular, a dual redundant bus comprises a bus controller 502, an A side data bus coupler 504, a B side data bus coupler 506, a first remote terminal 508, a second remote terminal 510, a third remote terminal 512. The A side data bus coupler 504 comprises three coils (514-518) that correspond to the three remote terminals (508-512). The B side data bus coupler 506 comprises three coils (520-524) that correspond to the three remote terminals (508-512).

In operation, an exemplary embodiment of the system and method of the present invention can isolate a fault to a specific coil within the data bus coupler by analyzing the test realists from within the bus controller. For example, bus fault detection and isolation software in the bus controller 502 may detect and isolate a fault to the second coil 522 in the B side data bus coupler 506 by determining that all three remote terminals (508-512) have passed on the A side and that remote terminals 1 and 3 (508 and 512) have passed on the B side. Thus, the second remote terminal (RT2) 510 has a fault in the connection between the remote terminal connector (not shown) and the second coil 522 in the B side data bus coupler 506.

The non-intrusive bus fault detection and isolation system and method, as shown in the above figures, may be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions described herein can be used to implement a non-intrusive bus fault detection and isolation system and method according to this invention.

Furthermore, the disclosed non-intrusive bus fault detection and isolation system and method may be readily implemented in software using object or object-oriented software development environments that provide portable source code that can be used on a variety of computer platforms. Alternatively, the non-intrusive bus fault detection and isolation system and method may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The non-intrusive bus fault detection and isolation system and method illustrated herein can readily be implemented in hardware and/or software using any known or later developed systems or structures, devices and/or software by those of ordinary skill in the applicable art from the functional description provided herein and with a general basic knowledge of the computer bus and test equipment arts.

Moreover, the disclosed non-intrusive bus fault detection and isolation system and method may be readily implemented in software executed on programmed general-purpose computer, a special purpose computer, a microprocessor, or the like. In these instances, the non-intrusive bus fault detection and isolation system and method of this invention can be implemented as a program embedded on a personal computer such as a JAVA® or CGI script, as a resource residing on a server or graphics workstation, as a routine embedded in a dedicated encoding/decoding system, or the like. The non-intrusive bus fault detection and isolation system and method can also be implemented by physically incorporating the non-intrusive bus fault detection and isolation system and method into a software and/or hardware system, such as the hardware and software systems of test equipment.

It is, therefore, apparent that there is provided in accordance with the present invention, a bus fault detection and isolation system and method. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A computer system for non-intrusive MIL STD 1553 bus fault detection and isolation, said computer system comprising:
a processor; and
a memory including software instructions adapted to cause the computer system to perform the steps of:
defining a first bus variable for a first bus in a redundant bus pair, the first bus variable including a built-in-test flag for each remote terminal connected to the first bus;
defining a second bus variable for a second bus in the redundant bus pair, the second bus variable including a built-in-test flag for each remote terminal connected to the second bus;
determining whether a fault has occurred on the first bus or the second bus based on a comparison of the first and second bus variables;
determining one or more bus coupler test variables corresponding to each bus coupler connected to the first bus or the second bus;
evaluating the bus coupler test variable for a bus coupler disposed at a physical end of the first bus and the second bus;
grouping the bus coupler test variables into logical segments and determining if a fault has occurred within a segment of the first bus or the second bus;
comparing the bus coupler test variables corresponding to the first bus with the bus coupler variables corresponding to the second bus in order to isolate a fault to a connection between a remote terminal and a first or second bus; and
comparing the built-in-test flags for each remote terminal for each of the first and second buses in order to isolate a fault to a connection between a remote terminal and a data bus coupler.

2. The computer system of claim 1, wherein the computer system is a bus controller and no additional apparatus is needed to detect and isolate faults on the bus.

3. The computer system of claim 1, wherein the software instructions further comprise creating one or more accumulator variables within the operating environment of a bus controller, each accumulator variable corresponding to a remote terminal, wherein the accumulator variable is incremented when a fault occurs in the remote terminal that the accumulator variable corresponds to such that intermittent failures may be detected.

4. The computer system of claim 1, wherein built-in-test data is correlated with physical configuration in order to perform fault isolation using a physical configuration mapping.

5. The computer system of claim 4, wherein the logical address of each remote terminal is not necessary to detect and isolate a fault.

6. A bus fault isolation method comprising:
defining a first bus variable for a first bus in a redundant bus pair, the first bus variable including a built-in-test flag for each remote terminal connected to the first bus;
defining a second bus variable for a second bus in the redundant bus pair, the second bus variable including a built-in-test flag for each remote terminal connected to the second bus;
determining whether a fault has occurred on the first bus or the second bus based on a comparison of the first and second bus variables;
determining one or more bus coupler test variables corresponding to each bus coupler connected to the first bus or the second bus;
evaluating the bus coupler test variable for a bus coupler at a physical end of the first bus and the second bus;
grouping the bus coupler test variables into logical segments and determining if a fault has occurred within a segment of the first bus or the second bus;
comparing the bus coupler test variables corresponding to the first bus with the bus coupler variables corresponding to the second bus in order to isolate a fault to a connection between a remote terminal and a first or second bus; and
comparing the built-in-test flags for each remote terminal for each of the first and second buses in order to isolate a fault to a connection between a remote terminal and a data bus coupler.

7. The bus fault isolation method of claim 6, wherein the first bus and the second bus comprise two redundant buses in a 1553 dual redundant bus system.

8. The bus fault isolation method of claim 6, wherein the method is adapted to be performed on a bus controller and no additional apparatus is needed to detect and isolate faults on the bus.

9. The bus fault isolation method of claim 8, further comprising creating one or more accumulator variables within the operating environment of the bus controller, each accumulator variable corresponding to a remote terminal, wherein the accumulator variable is incremented when a fault occurs in the remote terminal that the accumulator variable corresponds to such that intermittent failures may be detected.

10. The bus fault isolation method of claim 6, further comprising correlating built-in-test data with a physical configuration in order to perform fault isolation using a physical configuration mapping.

11. The bus fault isolation method of claim 6, wherein the logical address of each remote terminal is not necessary to detect and isolate a fault.

12. The bus fault isolation method of claim 6, further comprising determining that a fault has occurred on the first bus or the second bus.

13. A computer program product for bus fault detection and isolation, said computer program product comprising:
software instructions for enabling the computer to perform predetermined operations; and
a computer readable medium bearing the software instructions;
the predetermined operations including the steps of:
defining a first bus variable for a first bus in a redundant bus pair, the first bus variable including a built-in-test flag for each remote terminal connected to the first bus;
defining a second bus variable for a second bus in the redundant bus pair, the second bus variable including a built-in-test flag for each remote terminal connected to the second bus;
determining whether a fault has occurred on the first bus or the second bus based on a comparison of the first and second bus variables;
determining one or more bus coupler test variables corresponding to each bus coupler connected to the first bus or the second bus;
evaluating the bus coupler test variable for a bus coupler at a physical end of the first bus and the second bus;
grouping the bus coupler test variables into logical segments and determining if a fault has occurred within a segment of the first bus or the second bus;
comparing the bus coupler test variables corresponding to the first bus with the bus coupler variables corresponding to the second bus in order to isolate a fault to a connection between a remote terminal and a first or second bus; and
comparing the built-in-test flags for each remote terminal for each of the first and second buses in order to isolate a fault to a connection between a remote terminal and a data bus coupler.

14. The computer program product of claim 13, wherein the first bus and the second bus comprise two redundant buses in a MIL STD 1553 dual redundant bus system.

15. The computer program product of claim 13, wherein the computer program product is adapted to execute on a bus controller and no additional apparatus is needed to detect and isolate faults on the bus.

16. The computer program product of claim 15, further comprising creating one or more accumulator variables within the operating environment of the bus controller, each accumulator variable corresponding to a remote terminal, wherein the accumulator variable is incremented when a fault occurs in the remote terminal that the accumulator variable corresponds to such that intermittent failures may be detected.

17. The computer program product of claim 13, wherein the software instructions further comprise the step of correlating built-in-test data with a physical configuration in order to perform fault isolation using a physical configuration mapping.

18. The computer program product of claim 17, wherein the physical configuration mapping of built-in-test data permits fault detection and isolation such that a logical address of each remote terminal is not necessary to detect and isolate a fault.

19. The computer program product of claim 13, wherein the software instructions are configured to detect and isolate faults in real-time.

20. The computer program product of claim 19, wherein fault information is stored for later retrieval.
